(19) United States
(12) Patent Application Publication
(10) Pub. No.: US 2015/0150247 A1
(43) Pub. Date: Jun. 4, 2015

(54) USE OF ISOSORBIDE CAPRYLATES/CAPRATES IN DEODORANTS AND ANTIPERSPIRANTS

(71) Applicant: Andreas Wacker, Mannheim (DE)

(72) Inventor: Andreas Wacker, Mannheim (DE)

(73) Assignee: CLARIANT FINANCE (BVI) LIMITED, Tortola (VG)

(21) Appl. No.: 14/375,114

(22) PCT Filed: Jan. 30, 2013
(86) PCT No.: PCT/EP2013/000279

§ 371 Date: Jul. 28, 2014

(30) Foreign Application Priority Data
Feb. 4, 2012 (DE) 10 2012 002 272.7

(51) Int. Cl. A01N 25/10; A01N 25/02; A01N 37/38; A01N 57/20; A01N 33/02

(52) U.S. Cl. CPC A01N 25/10; A01N 57/20; A01N 33/02; A01N 37/38; A01N 25/02

(57) ABSTRACT

Compositions are described, containing: a) at least two water-soluble pesticides; b) one or more copolymers obtainable by copolymerization of i) glycerin, ii) at least one dicarboxylic acid and iii) at least one monocarboxylic acid; c) water; and optionally d) a co-solvent.

The invention relates to aqueous, storage-stable pesticide compositions which comprise copolymers.

Pesticides (acaricides, bactericides, fungicides, herbicides, insecticides, molluscicides, nematicides, and rodenticides) are chemical or natural substances which penetrate into plant cells, plant tissue, or parasitic organisms in or on the plant, and damage and/or destroy them. The major proportion of pesticides is accounted for by herbicides, followed by insecticides and fungicides.

Pesticides are used commonly in the form of liquid or solid concentrated preparations (formulations), which for the user make handling easier or make the active ingredient more effective. The formulations are commonly diluted with water before being used, and are subsequently broadcast by spray application.

Water-soluble concentrates (Soluble Liquids, abbreviated to SL) are one particularly important form of pesticide preparations. They play a large part particularly in the case of herbicides; the pesticides are often used as water-soluble alkali metal salts or ammonium salts, which are obtained by neutralizing the acid form of the herbicides with appropriate bases.

As a result of the extensive use of herbicides in agriculture, especially since the introduction of the herbicide-resistant, genetically modified crop plants, recent years have seen increased development of populations of resistant broadleaf weeds or grasses, which can no longer be controlled with one herbicide alone. One option for overcoming this problem is to use two or more herbicides at the same time, which, by virtue of their different modes of action, also catch weeds which are resistant to one particular herbicide.

In agriculture, combinations of two or more pesticides are often employed as a mixture in a spraying tank, in other words by the tank mix method. Here, the individual formulations are mixed with water in the spray tank and are then applied jointly. This procedure carries with it certain disadvantages.

First of all, compatibility problems may occur, resulting in the separation or precipitation of pesticide or other formulation ingredients. Secondly, the activity of the pesticides may be undesirably affected—for example, adjuvants which are present in each of the formulations but are not compatible together cancel out or else boost each other's effect, resulting in a reduced efficacy or in an unwanted boost in activity relative to crop plants, with the possible induction of plant damage.

In order to get around this problem, there is increased development of what are called combi formulations, which take account of the particularities of the individual pesticides used and which contain ingredients matched to one another, in order to ensure optimum mode of action and plant safety. This task, however, is often difficult, since it may be necessary to combine active ingredients that are not compatible with one another, thus raising automatically a risk of incompatibilities. This is manifested, for example, in the form of separations, precipitations, or thickening, rendering the formulations unusable. A particular difficulty is found to be combining two or more active ingredients, present in the form of their water-soluble salts, in a stable SL formulation.

WO 03/000055 describes pesticide preparations which comprise a copolymer of glycerol, a carboxylic acid, and a dicarboxylic acid as adjuvant. These copolymers significantly increase the effect of the pesticides, and are notable for their low toxicity and high eco-friendliness.

WO 2011/029561 describes the combination of a copolymer of glycerol, a carboxylic acid, and a dicarboxylic acid, together with amphoteric surfactants, as adjuvants, in glyphosate formulations, for example.

WO 2005/87007A1 describes formulations consisting of a defined ratio of glyphosate and an auxin herbicide. Various surfactants may be used in preparing these compositions; there is no mention of the copolymers of the formula (I).

WO 2010/102102A1 describes the use of alkyl polyglycosides (APGs) for preparing stable electrolytic aqueous pesticide mixtures.

WO 2010/123871A1 describes homogeneous aqueous herbicide preparations, stable on storage at a defined pH, of glyphosate ammonium salts and 2,4-D ammonium salts.

WO 2010/151622A2 teaches the combination of glyphosate salts with dicamba salts in aqueous formulations, which are likewise stable on storage at a defined pH.

A disadvantage of the combi formulations described before now is that oftentimes surfactants are used which are incapable of meeting the present strict requirements concerning toxicological and ecotoxicological safety, such as reduced irritation to the eyes, for example.

The object was that of developing storage-stable aqueous pesticide compositions which comprise at least two water-soluble pesticides and are based on a toxicologically and ecotoxicologically preferred surfactant system with reduced irritation to the eyes, this system being at the same time capable of enhancing the biological activity of the pesticides included.

Surprisingly the problem is solved by the pesticide composition comprising one or more copolymers obtainable by copolymerizing glycerol, at least one dicarboxylic acid, and at least one monocarboxylic acid.

The invention provides compositions comprising

a) at least two water-soluble pesticides,

b) one or more copolymers obtainable by copolymerizing
i) glycerol,
ii) at least one dicarboxylic acid, and
iii) at least one monocarboxylic acid, and

c) water,

d) optionally a co-solvent.

Water-soluble pesticides for the purposes of the invention are pesticides which at room temperature (25° C.) have a solubility of at least 50 g/l, preferably at least 100 g/l, in water.

Suitable water-soluble pesticides are preferably the water-soluble salts of herbicides having an acid function such as acifluorfen, aminopyralid, amitrole, asulam, benazolin, bentazone, bialaphos, bispyribac, bromacil, bromoxynil, bicyclopryon, chloramben, clopyralid, 2,4-D, 2,4-DB, dicamba, dichlorprop, difenzoquat, diquat, endothal, fenoxaprop, flamprop, flumiclorac, fluoroglycofen, fomesafen, fosamine, glufosinate, glyphosate, imazameth, imazamethabenz, imazamox, imazapic, imazapyr, imazaquin, imazethapyr, MCPA, MCPB, mecoprop, octanoic acid, paraquat, pelargonic acid, picloram, quizalofop, 2,3,6-TBA, and triclopyr.

More preferable here are the water-soluble salts of 2,4-D, bentazone, dicamba, fomesafen, glyphosate, glufosinate, MCPA, and paraquat.

Preferred among the water-soluble salts are in particular the alkali metal salts and ammonium salts, and of these in turn the potassium, ammonium, dimethylammonium, isopropylammonium, and (2-hydroxyethyl)trimethylammonium salts.

Especially preferred as component a) in the composition are combinations of precisely two water-soluble herbicides.

Among these two-way combinations, preference in turn is given in each case to glyphosate and 2,4-D, glyphosate and dicamba, glyphosate and fomesafen, glyphosate and glufosinate, 2,4-D and dicamba, glufosinate and 2,4-D, and also glufosinate and dicamba, and especially preferably in each case glyphosate and 2,4-D and also glyphosate and dicamba.

The ratio of the two water-soluble herbicides in these compositions is preferably between 9:1 and 1:9, more preferably 8:2 to 2:8, and especially preferably 7:3 to 3:7. These figures relate to the acid equivalents of the water-soluble herbicides.

For preparing the pesticide composition of the invention, the pesticides of component a) may be employed as a salt in solution in water, or else the insoluble herbicide in acid form is used as it is and is converted into the water-soluble salt only by addition of a suitable base. The preparation of such compositions in both ways is well known to the skilled person.

The preparations of the invention are suitable, for example, for treating broadleaf weeds and/or grasses, for use inter alia in crops of useful plants that are resistant to more than one herbicide, referred to as multi-herbicide-resistant genetically modified plants.

Preferred copolymers of component b) are obtainable by copolymerizing

i) glycerol,

ii) at least one dicarboxylic acid, and

iii) at least one monocarboxylic acid as per formula (I)

R¹—COOH (I),

where R¹ is (C₅-C₂₉)-alkyl; (C₇-C₂₉)-alkenyl; phenyl; or naphthyl,

and contain 19.9 to 99 wt % of component i), 0.1 to 30 wt % of component ii), and 0.9 to 80 wt % of component iii).

Preferred dicarboxylic acids of component ii) are selected from aromatic dicarboxylic acids. Particularly preferred dicarboxylic acids of component ii) are selected from phthalic acid, terephthalic acid, or isophthalic acid.

Preferred monocarboxylic acids of component iii) are selected from monocarboxylic acids of the formula (I) (formula R¹—COOH), in which R¹ is preferably an alkyl or alkenyl group and more preferably is a linear alkyl or alkenyl group. With further preference R¹ in the monocarboxylic acids of the formula (I), if it is an alkyl or alkenyl group, possesses 8 to 22 carbon atoms. Especially preferred are the monocarboxylic acids of the formula (I) in which R¹ is a fatty alkyl radical having 8 to 22 carbon atoms. With extraordinary preference, the monocarboxylic acids of the formula (I) are selected from coconut fatty acid or tallow fatty acid.

The preparation of the copolymers of component b) is described in EP 1 379 129 and WO 03/000055, for example.

The copolymers of component b) can be used to prepare aqueous pesticide compositions of at least two water-soluble pesticides that exhibit excellent storage stability. Moreover, the formulation is much less irritant to the eyes than its prior-art counterparts, by virtue of the use of the copolymers of component b). The copolymers of component b) also act as adjuvants and raise the biological activity of the pesticides of component a) that are present in the composition. Examples of further performance advantages include the low viscosity and the good solubility behavior in water.

The co-solvent d) optionally present may be a single solvent or a mixture of two or more solvents. Suitable for this purpose are all polar solvents which are compatible with the aqueous pesticide composition and form a homogeneous phase. Examples of suitable co-solvents are monohydric alcohols, such as methanol, ethanol, propanols, butanols, benzyl alcohol, or polyhydric alcohols such as ethylene glycol, diethylene glycol, propylene glycol, or glycerol, or polyglycols such as polyethylene glycols, polypropylene glycols, or mixed polyalkylene glycols (PAGs). Further suitable solvents are ethers such as, for example, propylene glycol monomethyl or dimethyl ether, dipropylene glycol monomethyl or dimethyl ether, amides such as, for example, N-methyl- or N-ethylpyrrolidone, and lactic, caprylic, or decanoic dimethyl amide.

Particularly suitable co-solvents are mono- or polyhydric alcohols, and especially suitable are di- or trihydric alcohols such as propylene glycol, glycerol, or polyethylene, polypropylene and/or mixed polyalkylene glycols (PAGs).

The co-solvents may additionally contribute to stabilizing the composition, by, for example, raising the low-temperature or high-temperature stability or by positively influencing other performance properties such as the viscosity.

The fraction of the co-solvents in the composition is commonly 10 to 250 g/l, preferably 20 to 200 g/l, and more preferably 30 to 150 g/l.

The copolymers of component b) allow the preparation of aqueous formulations with a particularly high loading, known as “high-load formulations”.

In one embodiment of the invention, therefore, the composition of the invention comprises the pesticides of component a) in a total amount of greater than 100 g/l, preferably greater than 200 g/l, and more preferably greater than 300 g/l. These quantity figures are based on the overall composition of the invention, on the sum total of the pesticides, and, in the case of pesticides used in the form of their water-soluble salts, on the amount of free acid, referred to as the “acid equivalent” (a.e.).

In a further preferred embodiment of the invention, the amount of component b) in the compositions of the invention is 20 to 250 g/l and preferably 50 to 200 g/l. These quantity figures are based on the overall composition of the invention.

The copolymers of component b) are used commonly in the form of solutions. For clarification it may be stated here that the quantity figures above are based on the active content of the copolymers of the formula (I) in the solution.

One important criterion for the storage stability of SL formulations is their phase stability. Especially important here is the temperature range within which an SL formulation is phase-stable. The upper limit of the phase stability is the point known as the cloud point. This is the temperature to which an aqueous formulation can be heated without phase separation. Until the cloud point is reached, the surfactants and the dissolved pesticides in the SL formulation are present in defined concentrations as a clear, homogeneous solution. On heating to temperatures above the cloud point, the hitherto transparent formulation first turns cloudy, the surfactant separates from the solution, and phase separation occurs on standing.

The cloud point of a composition is determined typically by heating the solution until clouding appears. The composition is subsequently left to cool with stirring and continual temperature monitoring. The temperature at which the clouded solution clears again is recorded as the measurement value of the cloud point.

The lower limit of the phase stability is important particularly in relation to storage at low temperature, such as in the winter, for example. When the temperature falls below the lower phase stability limit as well, there may be phase separation or instances of precipitation, or crystallization.

The compositions of the invention are notable in that they are phase-stable even at a temperature of preferably greater than 55° C., more preferably of greater than 70° C., and especially preferably of greater than 80° C.

Moreover, the compositions of the invention are notable in that they are phase-stable even at a temperature of preferably less than 10° C., more preferably of less than 0° C., and especially preferably of less than −10° C.

The compositions are broadcast on the fields in the form of spray mixtures. The spray mixture here is prepared by diluting the concentrated formulation with a defined amount of water.

The compositions of the invention may further comprise additional surfactants, preservatives, adjuvants, defoamers, or functional polymers.

The surfactants, generally speaking, may be all nonionic, amphoteric, cationic, or anionic surfactants that are compatible with the composition.

The surfactants may additionally raise the stability of the composition or boost biological activity.

Examples of nonionic surfactants are ethoxylates and alkoxylates of relatively long-chain aliphatic or aromatic alcohols, fatty amine ethoxylates, relatively long-chain ether amine alkoxylates, (optionally ethoxylated) sorbitan esters, and alkylpolyglycosides. Suitable amphoteric surfactants include long-chain alkyldimethyl betaines or alkyldimethylamine oxides, or alkyldimethylamine amidopropylamine oxides. Suitable examples among the anionic surfactants are ether sulfates of ethoxylated fatty alcohols, and reaction products of (optionally ethoxylated) long-chain alcohols with phosphoric acid derivatives. Suitable among “long-chain” are linear or branched hydrocarbon chains having at least 6 and not more than 22 carbon atoms.

Suitable preservatives include organic acids and their esters, examples being ascorbic acid, ascorbyl palmitate, sorbate, benzoic acid, methyl and propyl 4-hydroxybenzoate, propionates, phenol, as for example 2-phenylphenate, 1,2-benzisothiazolin-3-one, formaldehyde, sulfurous acid, and salts thereof.

Furthermore, the compositions may comprise other adjuvants which additionally boost the biological activity. Suitable compounds are known from the literature as adjuvants in aqueous pesticide compositions and are described in WO2009/029561, for example.

Suitable defoamers include fatty acid alkyl ester alkoxylates, organopolysiloxanes such as polydimethylsiloxanes and mixtures thereof with microfine, optionally silanized silica, perfluoroalkylphosphonates and -phosphinates; paraffins; waxes and microcrystalline waxes, and mixtures thereof with silanized silica. Also advantageous are mixtures of different foam inhibitors, examples being those made up of silicone oil, liquid paraffin and/or waxes.

The functional polymers which may be present in the composition are high molecular mass compounds of synthetic or natural origin, with a molar mass of greater than 10 000. The functional polymers may act, for example, as antidrift agents, or may boost the rain resistance.

The pH of the compositions is situated commonly in the range from 3.5 to 8.0, preferably 4.0 to 7.0, and more preferably 4.5 to 6.5 (measured in the form of a 1 wt % strength aqueous dilution). The pH is determined primarily by the pH values of the solutions of the aqueous pesticides, present in the form of salts of weak acids. By addition of acids or bases, the pH may be adjusted to a different value, differing from the original pH value of the mixture.

The high salt stability of the compositions of the invention in the aqueous medium, even in circumstances of high pesticide concentration and salt concentration, constitutes a great performance advantage. It makes it possible for agrochemical salts such as fertilizers, for example, to be included in the compositions as well.

In a further preferred embodiment of the invention, therefore, the compositions comprise one or more agrochemical salts, preferably ammonium salts.

More preferably the compositions comprise ammonium sulfate, ammonium nitrate, ammonium phosphate, ammonium thiocyanate and/or ammonium chloride.

In a further preferred embodiment of the invention, the compositions of the invention take the form of concentrated formulations which are diluted prior to use, more particularly with water (as for example “ready-to-use”, “in-can”, or “built-in” formulations), and comprise the one or more water-soluble pesticides of component a) in amounts of 5 to 80 wt %, preferably of 10 to 70 wt %, more preferably of 20 to 60 wt %, and the one or more copolymers of component b) in amounts of 1 to 25 wt %, preferably of 2 to 20 wt %, more preferably of 3 to 15 wt %. These quantity figures are based on the overall concentrated formulation, and in the case of pesticides which are used in the form of their water-soluble salts, are based on the amount of free acid, known as the “acid equivalent” (a.e.).

The compositions of the invention are applied to the fields preferably in the form of spray mixtures. These spray mixtures are prepared by diluting concentrated formulations with a defined amount of water.

In another preferred embodiment of the invention, the compositions of the invention take the form of spray mixtures and comprise 0.001 to 10 wt %, preferably 0.02 to 3 wt %, and more preferably 0.025 to 2 wt % of the one or more water-soluble pesticides of component a) and 0.001 to 3 wt %, preferably 0.005 to 1 wt %, and more preferably 0.01 to 0.5 wt % of the one or more copolymers of component b). The stated quantity figures are based on the overall spray mixture and, in the case of pesticides which are used in the form of their water-soluble salts, are based on the amount of free acid, known as the “acid equivalent” (a.e.).

The invention further relates to the use of the compositions of the invention for controlling and/or combating weeds, fungal diseases, or insect infestation. Preference is given to using the compositions of the invention for controlling and/or combating weeds.

### EXAMPLES

In the text below, the invention is illustrated by examples, which, however, should in no way be seen as a restriction.

### Example 1

Different pesticide compositions (see table 2) are prepared by mixing a commercial aqueous solution of glyphosate isopropylammonium salt (with 62 wt % of active ingredient) and a commercial aqueous solution of 2,4-D dimethylammonium salt (with 69 wt % of active ingredient) and further auxiliaries, and also water. The formulations contain 300 g/l glyphosate acid equivalent and 100 g/l 2,4-D acid equivalent. An overview of the adjuvants used is given in table 1.

TABLE 1
Overview of adjuvants A1 to A7

| Adjuvant | Composition |
|---|---|
| A1 (inventive) | Synergen ® GL 5 (copolymer consisting of |
| | glycerol, coconut fatty acid, and phthalic acid; |
| | Clariant product), 70 wt % solution in water |
| A2 (comparative) | Agnique ® AG 8107 (C_{8/10}-alkylpolyglycoside; |
| | Cognis product), 70 wt % solution in water |
| A3 (comparative) | Genamin ® T 150 (tallow fatty amine ethoxylate |
| | with 15 mol EO; Clariant product), approximately |
| | 100 wt % |
| A4 (comparative) | Genamin ® C 050 (coconut fatty amine ethoxylate |
| | with 5 mol EO; Clariant product), approximately |
| | 100 wt % |
| A5 (comparative) | Genagen ® KB (C_{12/14}-alkyldimethyl betaine; |
| | Clariant product), 30 wt % solution in water |
| A6 (comparative) | Synergen ® 9903 (alkylamido-N-[3- |
| | (dimethylamino)propyl], N-oxide; Clariant |
| | product), 30 wt % solution in water |
| A7 (comparative) | Genaminox ® LA (C_{12/14}-alkyldimethylamine oxide; |
| | Clariant product), 30 wt % solution in water |

TABLE 2
Glyphosate/2,4-D combi formulations (300 + 100 g/l a.e.)

| | Glyphosate | 2,4-D | | | | |
|---|---|---|---|---|---|---|
| | IPA | DMA | | | | |
| | (62 wt % | (69 wt % | | Adjuvant | Propylene | |
| | in water) | in water) | Adju- | amount | glycol | Water |
| Test | [g] | [g] | vant | [g] | [g] | [g] |
| I1-1 | 35.9 | 9.5 | A1 | 13.9 | 5.0 | 1.0 |
| C1-1 | 35.9 | 9.5 | none | 0 | 5.0 | 14.9 |
| C2-1 | 35.9 | 9.5 | A2 | 13.9 | 5.0 | 1.0 |
| C3-1 | 35.9 | 9.5 | A3 | 4.5 | 5.0 | 5.1 |
| C4-1 | 35.9 | 9.5 | A4 | 4.5 | 5.0 | 5.1 |
| C5-1 | 35.9 | 9.5 | A5 | 15 | 5.0 | 0 |
| C6-1 | 35.9 | 9.5 | A6 | 15 | 5.0 | 0 |
| C7-1 | 35.9 | 9.5 | A7 | 15 | 5.0 | 0 |

For all formulations, the phase stability is ascertained by determination of the cloud point and also of the low-temperature stability at 0° C. and −10° C. The results are set out in table 3.

TABLE 3
Cloud points and low-temperature stability
of compositions I1-1 to C7-1

| | Cloud point | Appearance | Appearance | Appearance |
|---|---|---|---|---|
| Test | [° C.] | at 25° C. | at 0° C. | at −10° C. |
| I1-1 | >95 | homogeneous | homogeneous | homogeneous |
| C1-1 | >95 | homogeneous | separates | separates |
| C2-1 | >95 | homogeneous | homogeneous | homogeneous |
| C3-1 | not | separates | separates | separates |
| | determined | | | |
| C4-1 | not | separates | separates | separates |
| | determined | | | |
| C5-1 | >95 | homogeneous | crystallizes | crystallizes |
| C6-1 | >95 | homogeneous | homogeneous | homogeneous |
| C7-1 | not | separates | homogeneous | separates |
| | determined | | | |

### Example 2

Different pesticide compositions (see table 4) are prepared by mixing a commercial aqueous solution of glyphosate isopropylammonium salt (with 62 wt % of active ingredient) and a commercial aqueous solution of 2,4-D dimethylammonium salt (with 69 wt % of active ingredient) and further auxiliaries, and also water. The formulations contain 200 g/l glyphosate acid equivalent and 200 g/l 2,4-D acid equivalent.

TABLE 4
Glyphosate/2,4-D combi formulations (200 + 200 g/l a.e.)

| | Glyphosate | 2,4-D | | | | |
|---|---|---|---|---|---|---|
| | IPA | DMA | | | | |
| | (62 wt % | (69 wt % | | Adjuvant | Propylene | |
| | in water) | in water) | Adju- | amount | glycol | Water |
| Test | [g] | [g] | vant | [g] | [g] | [g] |
| I1-2 | 24.0 | 19.0 | A1 | 7.5 | 5.0 | 11.5 |
| C1-2 | 24.0 | 19.0 | none | 0 | 5.0 | 19.0 |
| C2-2 | 24.0 | 19.0 | A2 | 7.5 | 5.0 | 11.5 |
| C3-2 | 24.0 | 19.0 | A3 | 5.3 | 5.0 | 13.7 |
| C4-2 | 24.0 | 19.0 | A4 | 5.3 | 5.0 | 13.7 |
| C5-2 | 24.0 | 19.0 | A5 | 19 | 5.0 | 0 |
| C6-2 | 24.0 | 19.0 | A6 | 19 | 5.0 | 0 |
| C7-2 | 24.0 | 19.0 | A7 | 19 | 5.0 | 0 |

For all formulations, the phase stability is ascertained by determination of the cloud point and also of the low-temperature stability at 0° C. and −10° C. The results are set out in table 5.

TABLE 5
Cloud points and low-temperature stability
of compositions I1-2 to C7-2

| | Cloud point | Appearance | Appearance | Appearance |
|---|---|---|---|---|
| Test | [° C.] | at 25° C. | at 0° C. | at −10° C. |
| I1-2 | >95 | homogeneous | homogeneous | homogeneous |
| C1-2 | >95 | homogeneous | separates | separates |
| C2-2 | >95 | homogeneous | homogeneous | homogeneous |
| C3-2 | not | separates | separates | separates |
| | determined | | | |
| C4-2 | not | separates | separates | separates |
| | determined | | | |
| C5-2 | >95 | homogeneous | crystallizes | crystallizes |
| C6-2 | >95 | homogeneous | homogeneous | separates |
| C7-2 | not | separates | separates | separates |
| | determined | | | |

### Example 3

Different pesticide compositions (see table 6) are prepared by mixing a commercial aqueous solution of glyphosate isopropylammonium salt (with 62 wt % of active ingredient) and a commercial aqueous solution of 2,4-D dimethylammonium salt (with 69 wt % of active ingredient) and further auxiliaries, and also water. The formulations contain 100 g/l glyphosate acid equivalent and 300 g/l 2,4-D acid equivalent.

TABLE 6
Glyphosate/2,4-D combi formulations (100 + 300 g/l a.e.)

| | Glyphosate | 2,4-D | | | | |
|---|---|---|---|---|---|---|
| | IPA | DMA | | | | |
| | (62 wt % | (69 wt % | | Adjuvant | Propylene | |
| | in water) | in water) | Adju- | amount | glycol | Water |
| Test | [g] | [g] | vant | [g] | [g] | [g] |
| I1-3 | 12.0 | 28.6 | A1 | 6.5 | 5.0 | 11.5 |
| C1-3 | 12.0 | 28.6 | none | 0 | 5.0 | 19.0 |
| C2-3 | 12.0 | 28.6 | A2 | 6.5 | 5.0 | 11.5 |
| C3-3 | 12.0 | 28.6 | A3 | 4.6 | 5.0 | 13.7 |
| C4-3 | 12.0 | 28.6 | A4 | 4.6 | 5.0 | 13.7 |
| C5-3 | 12.0 | 28.6 | A5 | 15.2 | 5.0 | 6.2 |
| C6-3 | 12.0 | 28.6 | A6 | 15.2 | 5.0 | 6.2 |
| C7-3 | 12.0 | 28.6 | A7 | 15.2 | 5.0 | 6.2 |

For all formulations, the phase stability is ascertained by determination of the cloud point and also of the low-temperature stability at 0° C. and −10° C. The results are set out in table 7.

TABLE 7
Cloud points and low-temperature stability
of compositions I1-3 to C7-3

| | Cloud point | Appearance | Appearance | Appearance |
|---|---|---|---|---|
| Test | [° C.] | at 25° C. | at 0° C. | at −10° C. |
| I1-3 | >95 | homogeneous | homogeneous | homogeneous |
| C1-3 | >95 | homogeneous | homogeneous | homogeneous |
| C2-3 | >95 | homogeneous | homogeneous | homogeneous |
| C3-3 | >95 | homogeneous | homogeneous | homogeneous |
| C4-3 | >95 | homogeneous | homogeneous | homogeneous |
| C5-3 | not | precipitates | precipitates | precipitates |
| | determined | | | |
| C6-3 | >95 | homogeneous | homogeneous | homogeneous |
| C7-3 | >95 | homogeneous | homogeneous | homogeneous |

The results of the tests show that the pesticide compositions of the invention which comprise the copolymer of component b) are significantly more stable, across a broad range of mixing ratios, then analogous compositions based on other products of the kind commonly used in aqueous pesticide compositions.

1. A composition comprising
a) at least two water-soluble pesticides having a water-solubility at 25° C. of at least 50 g/l,
b) at least one copolymer prepared by copolymerizing
i) glycerol,
ii) at least one dicarboxylic acid, and
iii) at least one monocarboxylic acid,
c) water, and
d) a co-solvent.

2. The composition as claimed in claim 1, wherein the water-soluble pesticides of component a) are selected from the group consisting of water-soluble herbicides.

3. The composition as claimed in claim 1, wherein the water-soluble pesticides of components a) are selected from the group consisting of the water-soluble salts of 2,4-D, bentazone, dicamba, fomesafen, glyphosate, glufosinate, MCPA, and paraquat.

4. The composition as claimed in claim 1, wherein component a) comprises exactly two water-soluble pesticides.

5. The composition as claimed in claim 4, wherein the exactly two water-soluble pesticides of component a) are selected from the group consisting of the combinations of glyphosate and 2,4-D, glyphosate and dicamba, glyphosate and fomesafen, glyphosate and glufosinate, 2,4-D and dicamba, glufosinate and 2,4-D, and glufosinate and dicamba.

6. The composition as claimed in claim 4, wherein the ratio of the two water-soluble herbicides in these combinations is between 9:1 and 1:9, based on the acid equivalents of the two water-soluble herbicides.

7. The composition as claimed in claim 1, wherein the at least one copolymer of component b) are selected from the group consisting of copolymers prepared by copolymerizing
i) glycerol,
ii) at least one dicarboxylic acid, and
iii) at least one monocarboxylic acid as per formula (I)
R¹—COOH (I),
where R¹ is (C₅-C₂₉)-alkyl; (C₇-C₂₉)-alkenyl; phenyl; or naphthyl, and comprise 19.9 to 99 wt % of component i), 0.1 to 30 wt % of component ii), and 0.9 to 80 wt % of component iii).

8. The composition as claimed in claim 1, wherein the co-solvent d) is a polar solvent which is compatible with the aqueous pesticide composition and forms a homogeneous phase.

9. The composition as claimed in claim 1, wherein the total amount of the pesticides of component a) in the composition is greater than 100 g/l, based on their acid equivalent.

10. The composition as claimed in claim 1, wherein the amount of the copolymers of component b) in the composition is from 20 to 250 g/l.

11. The composition as claimed in claim 1, which is phase-stable at a temperature of greater than 55° C.

12. The composition as claimed in claim 1, which is phase-stable at a temperature of less than 10° C.

13. The composition as claimed in claim 1, which comprises at least one agrochemical salt.

14. The composition as claimed in claim 1, which is present in the form of a concentrated formulation which is diluted prior to use, and which comprises 5 to 80 wt %, of the at least two water-soluble pesticides of component a) and 1 to 25 wt %, of the at least one copolymer of component b).

15. The composition as claimed in claim 1, which takes the form of a spray mixture and comprises 0.001 to 10 wt %, of the at least two water-soluble pesticides of component a) and 0.001 to 3 wt %, of the at least one copolymer of component b).

16. A process for controlling and/or combating weeds, fungal diseases, or insect infestation, comprising the step of contacting the weeds, fungal diseases, or insects with a composition comprising
a) at least two water-soluble pesticides having a water-solubility at 25° C. of at least 50 g/l,
b) b) at least one copolymer prepared by copolymerizing
i) glycerol,
ii) at least one dicarboxylic acid, and
iii) at least one monocarboxylic acid,
c) water, and
d) a co-solvent.
